(19) United States
(12) Patent Application Publication
(10) Pub. No.: US 2013/0109471 A1
(43) Pub. Date: May 2, 2013

(54) GAME SYSTEM AND COMPUTER PROGRAM FOR SAME

(71) Applicant: Takao Yamamoto, Minato-ku (JP)

(72) Inventor: Takao Yamamoto, Minato-ku (JP)

(21) Appl. No.: 13/583,893

(22) PCT Filed: Mar. 11, 2011
(86) PCT No.: PCT/JP2011/055826

§ 371 Date: Jan. 8, 2013

(30) Foreign Application Priority Data
Mar. 15, 2010 (JP) 2010-058100

(51) Int. Cl. A63F 13/00

(52) U.S. Cl. 463/31; 273/138.2

(57) ABSTRACT

A game system (1) is provided with a monitor (3) which displays a game screen, a touch panel (4) which accepts an operation of a player and a sequence data storage device which stores sequence data in which operation time of the touch panel (4) during a game is described. The game system (1) makes the monitor (3) display a game area (A) where an object (O) for indicating an operation to the touch panel (4) and a determination line (L) where the object (O) moves to arrive at an operation time indicated in the sequence data appear and determines a direction of a new determination line (L) extending from the object (O) based on the operation of the touch panel (4) when the object (O) moving along a predetermined path arrives at an operation position coinciding with the determination line (L).

### TECHNICAL FIELD

The present invention relates to a game system which indicates an operation time of an operating device accepting a player's operation to the player and a computer program for the same.

### BACKGROUND ART

There is a game machine which operates an operating portion in rhythm to music (see, for example, Patent Literature 1). In this game machine, a play is evaluated based on the operation timing by operating the operating device in rhythm to music when an operation indicator indicating the operation time moves to a predetermined operation position.
Patent Literature 1: JP-A-2000-155543.

### SUMMARY OF INVENTION

### Technical Problem

Since an operation position of an operation indicator is determined in advance, a player can predict a next operation to some extent. Therefore, a game easily becomes monotonous.

Therefore, the present invention aims to provide a game system, capable of changing an operation position of an operation indicator indicating an operation time, and a computer program for the same.

### Solution to Problem

The game system of the present invention is a game system comprising: a display device which displays a game screen;

an operating device which accepts an operation of a player; a sequence data storage device which stores sequence data in which operation time of the operating device during a game is described; a game area display device which makes the display device display a game area where an operation indicator for indicating an operation to the operating device and an operation reference portion where the operation indicator moves to arrive at an operation time indicated in the sequence data appear; and a direction determination device which determines a direction of a new operation reference portion extending from the operation indicator based on the operation of the operating device when the operation indicator moving along a predetermined path arrives at an operation position coinciding with the operation reference portion.

According to the game system of the present invention, the operation indicator to be operated by the player moves according to the path data and the new operation reference portion extends in a certain direction from the position at which the operation indicator is located by operating the operating device when the operation indicator coincides with the operation reference portion. The operation indicator to be operated next time arrives in the new operation reference portion at the corresponding operation time. the operation position can be set using the entire game are because the positions at which the operation reference portion appears are different in the game area in each operation. Therefore, while checking the entire game area, the player has to operate the operating device at the operation timing when the operation indicator coinciding with the operation reference portion. Hence, the game element can be diversified and it is possible to enhance the enjoyability of game.

As one aspect of the game system of the present invention, after the direction determination device determines an operation coordinates of the operation indicator to operate next with respect to the operation indicator to be operated by the player, the direction determination device determines the direction of the operation reference portion so as to extend in a direction of the operation coordinates. According to this, the direction in which the operation reference portion appears is determined after the determination of the next operation coordinates. Therefore, the operation reference portion can appear in the game area in various directions. In this aspect, comprising an operation coordinates data storage device which stores operation coordinates data in which operation coordinates of the operation position are described in association with the order of operations. Further, comprising an operation coordinates determination device which selects the operation coordinates of the operation position where the operation indicator arrives in the operation reference portion by a lottery from the coordinates in the game area.

As one aspect of the game system of the present invention, the direction determination device determines a direction of the new operation reference portion so as to cross a path where a next operation indicator to arrive the new operation reference portion moves. According to this, when the path of the operation indicator arriving with respect to the newly extending operation reference portion is determined in advance, the new operation reference portion may extend in a direction crossing the path. In this way, the crossing point may be set as the next operation position. The generation of the generation line is diversified, and the progress of the game is diversified.

As one aspect of the game system of the present invention, comprising a path generation device which generates a path of the operation indicator arriving at the operation coordinates to be operated next so as to cross at a certain position of a candidate of the operation coordinates to be operated next provided on the circumference having a predetermined radius around the operation position. According to this, in a state that the operation coordinates are not determined with one, the path is generated to cross a certain one among the candidates of the operation coordinates. The crossing point becomes a next operation position. Therefore, the generation of the path and the determination line is diversified and the progress of the game is diversified.

As one aspect of the game system of the present invention, further comprising a path data storage device which stores path data in which the appearance position of the operation indicator and the path where the operation indicator appearing from the appearance position moves are described, wherein the path of the operation indicator determines based on the path data. According to this, the paths according to the progress of the game may be sequentially determined by selecting the path data.

In the aspect in which the path data storage device is provided, further comprising a path determination device which selects the path data including the operation coordinates of the operation reference portion at which the operation indicator to determine the path arrives. According to this, when the operation position of the operation indicator is determined, path data suitable for the operation position can be selected.

In the aspect in which the path determination device is provided, the path determination device selects the path data that the number of rebounding points where the operation indicator moving in the game area contacts with the border line surrounding the game area and rebounds is equal to or less than a predetermined number. According to this, the path data can be selected in a range that does not disrupt the progress of the game. Therefore, a difficulty level of the game can be adjusted and it is possible to enhance the enjoyability of game.

In the aspect in which the path determination device is provided, in the sequence data, an appearance time of the operation indicator corresponding to the operation time is described, and the path determination device determines the velocity of the moving operation indicator based on the appearance duration determined based on the appearance time and the operation time and the appearance position and the operation position of the path of the corresponding operation indicator, and selects the path data that the velocity is within a predetermined range. According to this, the path data can be selected in a range that does not disrupt the progress of the game. Therefore, a difficulty level of the game can be adjusted and it is possible to enhance the enjoyability of game.

In the aspect in which the path determination device is provided, the path determination device selects the path data that a crossing angle between the operation reference portion to coincide with the operation indicator and the path of the moving operation indicator is equal to or greater than a predetermined angle. According to this, the path data can be selected in a range that does not disrupt the progress of the game. Therefore, a difficulty level of the game can be adjusted and it is possible to enhance the enjoyability of game.

The computer program of the present invention is a computer program for a game system comprising: a display device which displays a game screen; an operating device which accepts an operation of a player; and a sequence data storage device which stores sequence data in which operation time of the operating device during a game is described; wherein the computer program causes the game system to serve as: a game area display device which makes the display device display a game area where an operation indicator for indicating an operation to the operating device and an operation reference portion where the operation indicator moves to arrive at an operation time indicated in the sequence data appear; and a direction determination device which determines a direction of a new operation reference portion extending from the operation indicator based on the operation of the operating device when the operation indicator moving along a predetermined path arrives at an operation position coinciding with the operation reference portion.

It is possible to serve as a game system of the present invention by executing the program of the present invention on the computer of the game system.

### Advantageous Effects of Invention

As described above, according to the present invention, the operation indicator to be operated by the player moves according to the path data and the new operation reference portion extends in a certain direction from the position at which the operation indicator is located by operating the operating device when the operation indicator coincides with the operation reference portion. The operation indicator to be operated next time arrives in the new operation reference portion at the corresponding operation time. the operation position can be set using the entire game are because the positions at which the operation reference portion appears are different in the game area in each operation. Therefore, while checking the entire game area, the player has to operate the operating device at the operation timing when the operation indicator coinciding with the operation reference portion. Hence, the game element can be diversified and it is possible to enhance the enjoyability of game.

### BRIEF DESCRIPTION OF DRAWINGS

FIG. 1 is a diagrammatic illustration of a game machine to which a game system is applied according to one aspect of the present invention.

FIG. 2 is a functional block diagram of a game machine.

FIG. 3A is a diagram showing an outline of a game area.

FIG. 3B is a diagram showing an outline of a game area subsequent to FIG. 3A when a game is progressed.

FIG. 3C is a diagram showing an outline of a game area subsequent to FIG. 3B when a game is progressed.

FIG. 4 is a diagram showing one example of a configuration of sequence data.

FIG. 5 is a flowchart showing a sequence processing routine to be executed by a game control portion.

FIG. 6 is a flowchart showing a determination line generation processing routine to be executed by a game control portion.

FIG. 7 is a flowchart showing a path determination processing routine to be executed by a game control portion.

FIG. 8 is a flowchart showing a sequence processing routine to be executed by a game control portion according to one of variations.

FIG. 9 is a flowchart showing a determination line generation processing routine to be executed by a game control portion according to one of variations.

FIG. 10 is a flowchart showing a sequence processing routine to be executed by a game control portion according to another variation.

FIG. 11 is a flowchart showing a path generation processing routine to be executed by a game control portion according to another variation.

### DESCRIPTION OF EMBODIMENTS

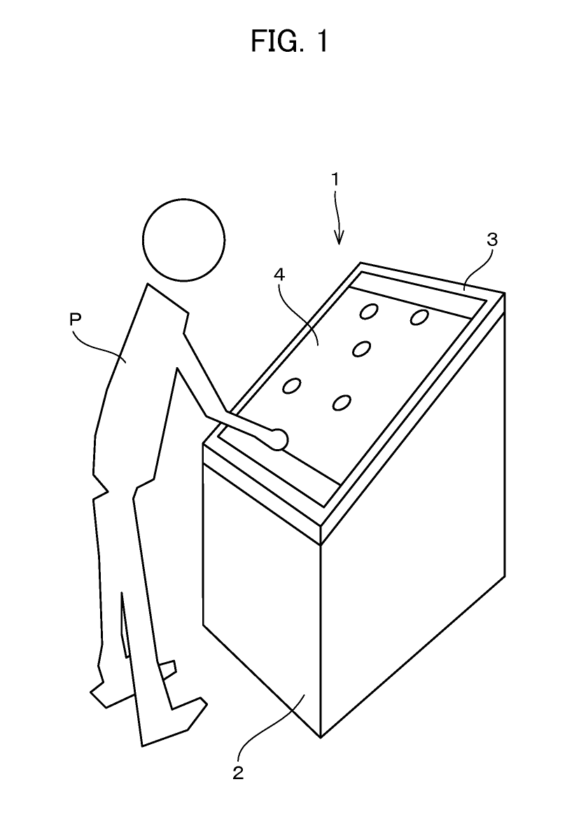

FIG. 1 is a diagrammatic illustration of a game machine to which a game system is applied according to one aspect of the present invention. The game machine 1 is a business use game machine installed in a commercial facility, and is configured as a music game machine which evaluates operation timings by one or more players P in accordance with the music. The game machine 1 is provided with a chassis 2 and a monitor 3 disposed on a top surface of the chassis 2 inclined toward the player P. On the surface of the monitor 3, a transparent touch panel 4 is overlapped. The touch panel 4 is conventional input device which outputs signals according to touch positions where the player P touches the touch panel 4 with his or her finger or the like. Further, the monitor 3 serves as a display device and the touch panel 4 serves as an operation device. In addition, the game machine 1 is provided with various input devices and output devices to be equipped in the business use game machine, such as buttons to make a choice or a determination, a power switch, a power lamp, or the like, but illustration thereof is omitted in FIG. 1.

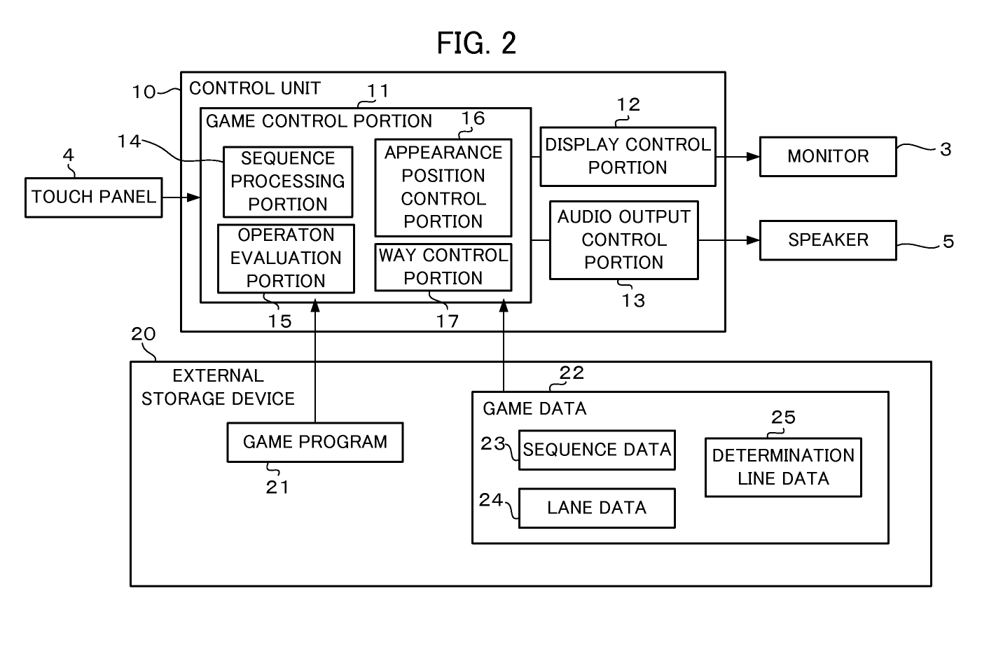

A functional block diagram of the game machine 1 is illustrated in FIG. 2. The game machine 1 is provided with a control unit 10 as a computer. The control unit 10 is provided with a game control portion 11, and a display control portion 12 and an audio output control portion 13 operating according to an output of the game control portion 11. The game control portion 11 is configured as a unit in which a microprocessor and various peripheral devices, such as an internal storage device (for example, a ROM and a RAM) necessary for the operation of the microprocessor, are combined. To the game control portion 11, there is connected the touch panel 4 to accept operation by the player. The display control portion 12 displays a predetermined image on the monitor 3 by drawing an image on a frame buffer according to image data provided by the game control portion 11, and issuing a image signal corresponding to the image to the monitor 3. The audio output control portion 13 makes a speaker 5 reproduce predetermined sounds (including a music sound and the like) by generating audio playback signals in accordance with audio playback data which are provided by the game control portion11, and issuing them to the speaker 5.

Further, an external storage device 20 is connected to the game control portion 11. As the external storage device 20, a nonvolatile semiconductor memory device such as EEPROM, or a storage medium such as a magnetic storage device which can retain a memory even when power is not supplied, is used. The storage medium of the external storage device 20 may be detachable from the game machine 1.

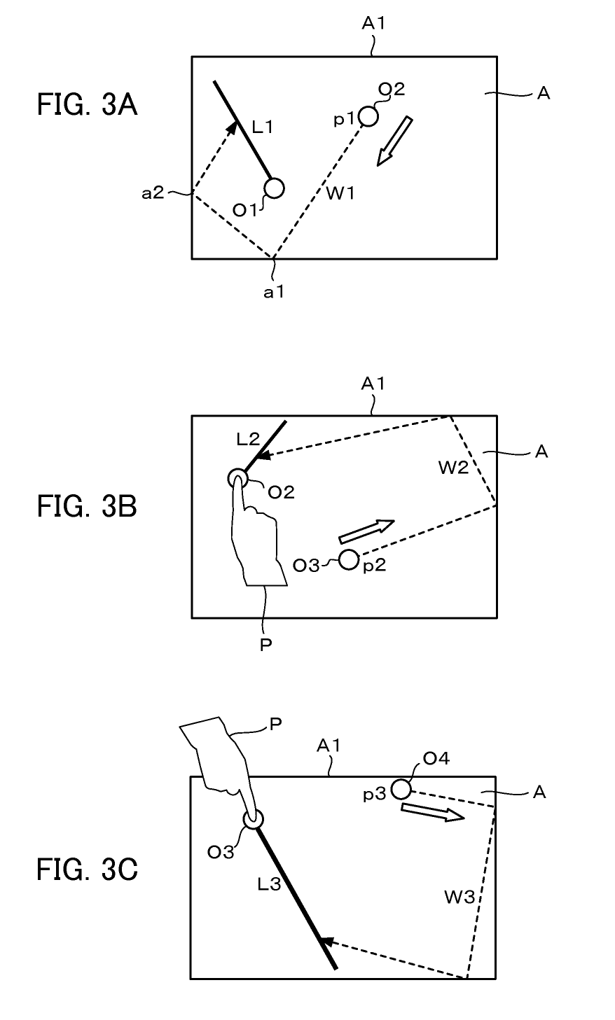

In the external storage device 20, a game program 21 and game data 22 are recorded. The game program 21 is a computer program necessary for executing a predetermined music game on the game machine 1. When the game machine 1 starts up, the game control portion 11 executes various initial settings necessary for operations of the game machine 1 by executing an operation program stored in the internal storage device, and subsequently, sets environments to execute the music game based on the game program 21 by executing the game program 21 read from the external storage device 20. By the execution of the game program 21, a sequence processing portion 14, a game area display portion 15, a path determination portion 16, and a direction determination portion 17 are generated in the game control portion 11. The sequence processing portion 14, the game area display portion 15, the path determination portion 16 and the direction determination portion 17 are logical devices provided by a combination of computer hardware and a computer program. The sequence processing portion 14 executes processing necessary of the progress of the music game such as indications of the operation to the player P in accordance with the playback of the music (music piece) selected by the player P and generations of the sound effect in accordance with the operation of the player P. The game area display portion 15 executes processing to display the game area A where an object O as an operation indicator and a determination line L as an operation reference portion to be described later appear on the monitor 3 (see FIG. 3). The path determination portion 16 executes processing to determine an appearance position p where the object O appears in the game area A and a path of the object O to the operation position. The direction determination portion 17 executes processing to determine a direction in which a new determination line L extends from the object O which is located on the determination line L by moving based on the operation of the player P to the touch panel 4. Further, in the game control portion 11, various logical devices other than those described above may be generated by the execution of the game program 21.

In the game data 22, various types of data, which are referred to at the time of the execution of the music game based on the game program 21, are included. For example, sequence data 23, path data 24 and operation coordinates data 25 are included in the game data 22. The sequence data 23 is data which defines an operation or the like to indicate to the player P. At least a piece of the sequence data 23 is prepared for a piece of the music data. Many different types of the sequence data 23 which changes a level of difficulty or the like may be prepared for a music piece. The path data 24 is data which records coordinates of the appearing object O and a moving path of the object O on the game area A. A plurality of path data 24 is recorded with identifiable codes respectively as the path of the object O which can appear. The operation coordinates data 25 is data which records an operation position of the object O to operate with the touch panel 4 by the player P based on the sequence data 23 as a position coordinates on the game area A. Therefore, the operation coordinates data 25 is prepared in correspondence to the operation time of the sequence data 23. In addition, in the game data 22, music data necessary for reproducing a music, which is a subject of a game, from the speaker 5, sound effect data which records many different types of sound effect to be issued from the speaker 5 in response to the operation of the player P in correspondence to unique codes at each sound effect, and image data for displaying a background image on the game screen, various types of objects O, icons or the like on the monitor 3, are included.

Next, an outline of the music game executed in the game machine 1 will be described. FIG. 3A shows an outline of a game area A. Outside the game area A of the game screen on the monitor 3, information necessary for the progress of the game such as score which is not shown in FIG. 3 is displayed. At the time of starting the game, an object O1 and d determination line L1 extending from the object O1 are displayed in the game area A (also, unless otherwise distinguished, referential marks are represented by O and L, respectively). During the execution of the music game, that is, during the reproduction of the music piece is progressed, the object O is displayed based on the sequence data 23 in the game area A. Further, a display type of the object O1 and the determination line L1 shown in FIG. 3A is an example. Only the determination line L1 may be displayed in the game area A. After the game is started, an object O2 to operate first by the player P at an appropriate timing of the music piece is displayed at an appearance position p1 (FIG. 3A). The object O2 moves along a path W1 (unless otherwise distinguished, the path is represented by referential mark W) such that the object O2 coinciding with the determination line L1 at the operation time in accordance with the sequence data 23. The path W1 is specified in advance with respect to the object O2. The operation timing of the player P is evaluated by touching the position displayed the object O2 on the touch panel 4 at the timing when the object O2 coincides with the determination line L1. The operation of the player P is evaluated based on the difference between the time when the player P touched the touch panel 4 and the time when the object O2 arrives at the determination line L1 as the evaluation of the operation timing. As the difference is smaller, the operation of the player P is evaluated more highly.

When the player P touches the object O2, a new determination line L2 for a next operation extends from the object O2 in a direction determined by the direction determination section 17 (FIG. 3B). Further, processing by the direction determination portion 17 will be described later. The object O2 disappears from the game area A while the determination line L2 appears and a new object O3 to coincide with the determination line L2 appears at an appearance position p2 at an appropriate time. Further, when the player P cannot touch the object O2 in an allowable operation time, the determination line L appears from operation coordinates of the object O to be operated. Alternatively, the object O2 which cannot be touched disappears from the game area A, and a display control may be performed such that a new determination line L appears from the disappearance position. The object O3 moves on the path W2 to coincide with the determination line L2 at the operation time of the object O3 described in the sequence data 23. When the player P touches the object O3 at the timing when the object O3 coincides with the determination line L2, a new determination line L3 appears from the object O3, a new object O4 appears at an appearance position p3 and the object O4 moves along the path W3 (FIG. 3C). Further, subsequently, the same appearance of the object O and the determination line L are repeated, and the music game is progressed according to the sequence data 23 until the reproduction of the music piece is finished. The appearance position of the object O is not limited to the appearance position p in the game area A, and the object O may appear from a border line A1 of the game area A. In this case, the appearance position p may be set to certain coordinates on the border line A1.

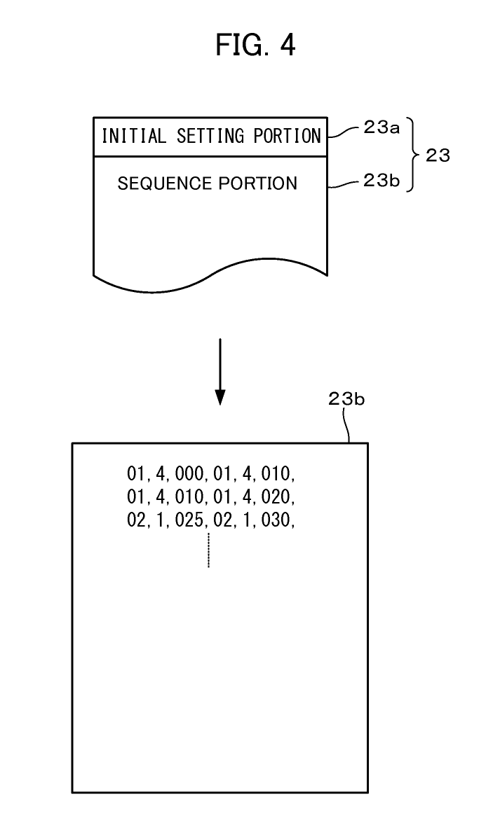

Next, further details about the sequence data 23 will be described with reference to FIG. 4. As shown in FIG. 4, the sequence data 23 is included in a condition definition portion 23a and a sequence portion 23b. In the condition definition portion 23a, information to specify a execution conditions of the game which differs from one music piece to another such as information to specify the tempo of the music (BPM, for example) and the sound effect when the player P operates the touch panel 4 and information to specify a correspondence relation between the difference of the above-described operations and the evaluation is described.

In contrast, in the sequence section 23b, the appearance time of making the object O appear in the game area A during the music and the operation time to touch the appearing object O corresponding to the respective object O are described. As a part of the sequence portion 23b is shown in FIG. 4 for example, the sequence portion 23b is configured as set of plural records where the appearance time and the operation time corresponding to the respective object O are described. In the appearance time and the operation time of the each record, bar number on the music piece, the number of beat and the time in the beat which are delimited by a comma are described respectively. The time in the beat is elapsed time since the top of a beat and expressed as number from the top of the beat to divide time of a beat into n equal parts. For example, if n=100, the second bar first beat and the time when quarter passed from the top of the beat are specified as appearance timing, it is described as “02, 1, 025”.

In the case of FIG. 4, the object O1 coinciding with the determination line L1 on the top of the first bar second beat (000) is touch operated (in the sequence portion 23b, it is specified as “line_1”). In the example of FIG. 4, the object O appears at a starting time (000) of the first bar fourth beat, and the object O moves along the way W and coincides with the determination line L at a timing elapsed from the starting time of the first bar fourth beat by “010”. In this manner, the appearance time and the operation time are specified. Further, in FIG. 4, the condition definition portion 23a is provided at only the head of the sequence data 23, but a condition setting portion (not shown) including information to specify the tempo of the music, information to specify sound effects to generate when the touch panel 4 is operated or the like as in the condition definition section 23a, may be included in appropriate location in the middle of the sequence section 23b. It is possible to execute the processing such as change of the tempo on the music piece and change of assigned sound effect by including such condition setting information in the sequence portion 23b.

Next, processing of the game control portion 11 when the music game is executed in the game machine 1 will be described. The game control portion 11 executes initial settings necessary for the execution of the music game by reading the game program 21 and then stands by for the indications by the player P to start the game. The operation to identify data for use in the game such as selections of the music piece played on the game or the level of difficulty is included in the indication to start the game. Acceptance of these indications may follow the same procedure as the conventional music game and the like.

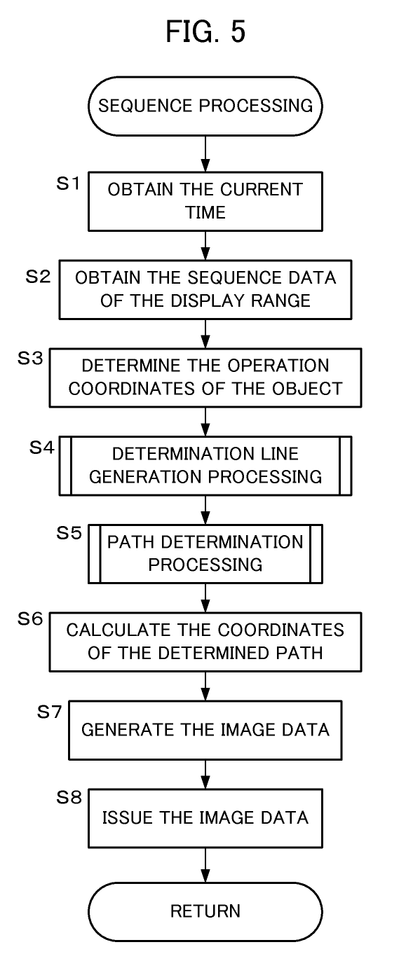

When the game's beginning is indicated, the game control portion 11 starts to play the music from the speaker 5 by reading the music data corresponding to the music selected by the player P and outputting the music data at the audio output control portion 13. The game control portion 11 displays the game area A on the monitor 3 by issuing the image data necessary for drawings of the game area A to the display control portion 12 with reference to the image data by reading the sequence data 23 corresponding to the selection of the player P in synchronization with the playback of the music piece. During the execution of the music game, the game control portion 11 repeatedly executes a sequence processing routine shown in FIG. 5 at predetermined intervals as the processing necessary for the display of the game area A and the like. The sequence processing portion 14 executes the routine shown in FIG. 5 and a part thereof executes The direction determination portion 17, the path determination portion 16 and the game area display potion 15.

When the sequence processing routine shown in FIG. 5 is started, the sequence processing portion 14 of the game control portion 11 obtains a current time on the music piece in the first step S1. For example, timer is started with an internal clock in the game control portion 11 on the basis of the point of playback starting time of the music piece and the current time is obtained from the value of the internal clock. In the next step S2, the sequence processing portion 14 obtains data of the appearance time and the operation time from the sequence data 23 existing in the duration corresponding to a display range of the game area A. As one example of the display range, a time range corresponding to two bars of the music piece from the current time to the future is configured.

In the next step S3, the sequence processing section 14 determines operation coordinates of the object O at the operation time obtained in the step S2. The sequence processing portion 14 obtains the operation coordinates corresponding to the operation time which is wanted to be obtained by referring to the operation coordinates data 25. The sequence processing portion 14 determines the determination line L in the next step S4, and instructs the direction determination portion 17 to execute determination line generation processing of calculating coordinates for displaying the determination line L in the game area A. The direction determination portion 17 obtains coordinates necessary for displaying the determination line L by executing determination line generation processing to be described later, and notifies the coordinates to the sequence processing portion 14. Further, in the step S4, when the determination line L is determined in the already executed processing, the previous processing result may be used, and new determination line generation processing may be executed.

In the next step S5, the sequence processing portion 14 instructs the path determination portion 16 to execute path determination processing of determining an appearance position and a path of the object O. Details of the path determination processing will be described later. Path data selected in the target object O is determined by the execution of the path determination processing. In the next step S6, the sequence processing portion 14 obtains appearance coordinates and coordinates necessary for displaying the moving path of the object O in the game area A based on the path data 24 selected in the step S5. In the next step S7, the sequence processing portion 14 instructs the game area display portion 15 to execute processing of generating image data necessary for drawing the game area A based on the determination line L and the coordinates of the object O calculated in these steps S4 and S6. In the game area display portion 15, image data is generated such that the determination line L and the object O are arranged in the game area A with respect to the calculated coordinates. The image of the determination line L or the like may be obtained from the image data of the game data 22. In the next step S8, the sequence processing portion 14 issues the image data generated in the game area display portion 15 to the display control portion 12. In this way, the game area A is displayed on the monitor 3. After the processing of the step 8, the sequence processing portion 14 quits the sequence processing routine. It is displayed in the game area A such that the determination line L appears in a predetermined direction and the object O appears from the appearance position determined by the above processing at the appearance time described in the sequence data 23 and moves along a predetermined path coinciding with the determination line L at the operation time described in the sequence data 23 by repetitively executing the above processing.

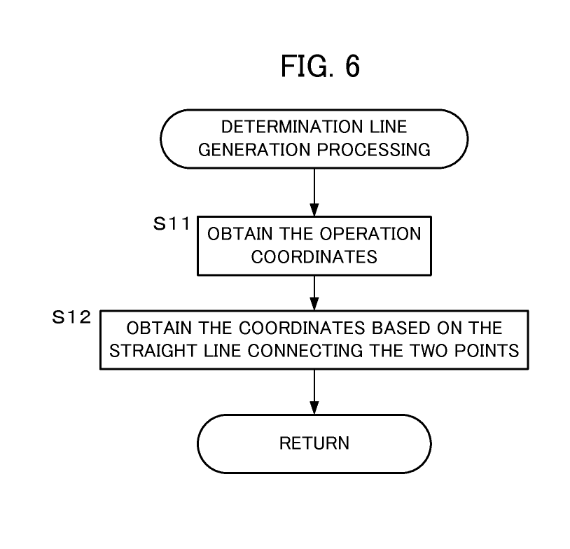

Next, it will be described the determination line generation processing routine executed by the direction determination portion 17 with reference to FIG. 6. When the determination line generation processing of FIG. 6 is executed, in the step S11, the direction determination portion 17 first obtains the operation coordinates determined in step S3 of the above-described sequence processing routine. In the next step S12, the direction determination portion 17 obtains coordinates of the determination line L by connecting two successive operation coordinates. The determination line L extends from the operation position of the object O corresponding to the operation time which becomes a reference (reference operation time). For this reason, the direction of the determination line L extending from the operation position (reference operation position) corresponding to the reference operation time is determined by connecting with a straight line between operation coordinates respectively corresponding to the reference operation time and the operation time to be operated next time with respect to the reference operation time and the determination line L to be displayed is determined. Coordinates necessary for displaying are obtained by calculating the determined determination line L. Therefore, the direction determination portion 17 can obtain coordinates necessary for displaying the determination line L by connecting with a straight line between the operation coordinates in which the operation time on the game area A is continued. Further, the determination line L extending from the reference operation position can extend beyond the operation coordinates of a next operation position. The direction determination portion 17 notifies the coordinates of the determination line L to the sequence control portion 14, and quits the processing. According to the above processing, it is possible to obtain information necessary for displaying the determination line L extending when the player P touches the object O.

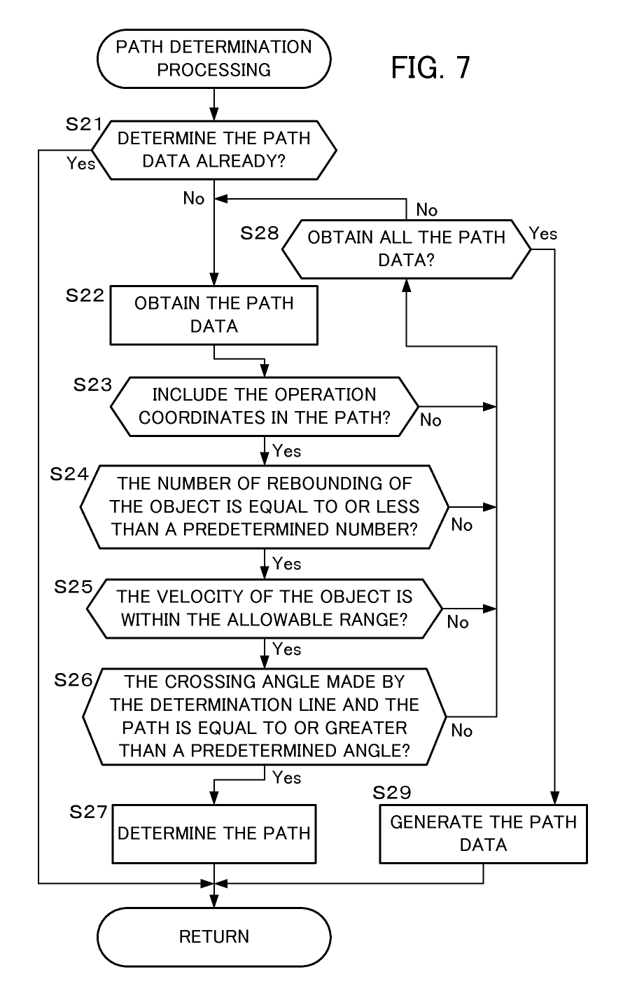

Next, the path determination processing routine which is executed by the path determination portion 16 will be described with reference to FIG. 7. When the path determination processing of FIG. 7 is executed, the path determination portion 16 first determines in the step S21 whether or not the path data is already determined. When the path of the object O which is a target in processing after the step S22 to be described later is already determined, the path determination portion 16 quits the processing. On the other hand, when the path is not yet determined, the path determination portion 16 proceeds to step S22 to obtain arbitrary path data 24 by referring to the path data 24. The path data may be randomly selected, and the selection order may be determined by certain weights. In the case of the random selection, a lottery is performed using a random number or the like. The path data 24 corresponding to the random number generated by the lottery is determined. The random number may be allocated to the path data 24.

In the next step S23, the path determination portion 16 determines whether or not the operation coordinates are included in the selected path data 24. When the operation coordinates are included in the path, the object O moving along the path can move up to the operation position.

When the operation coordinates are included, the path determination portion 16 proceeds to the next step S24 and determines whether or not the number of rebounding of the object O in the path is equal to or less than a predetermined number. The rebounding of the object O refers to rebounding of the object O while contacting the border line A1 surrounding all sides of the game area A. A moving direction of the object O is changed by this rebounding. As one example, in FIG. 3A, two rebounding points a1 and a2 exist. In the path data 24, although the number of rebounding and the rebounding position are determined in advance, the rebounding points may be reduced because a distance between the appearance position and the arrival position is shortened by the position of the arriving object. The path determination portion 16 counts the number of rebounding points from the operation coordinates and the path, and determines whether or not the count number is equal to or less than a predetermined number. The predetermined number may be set to, for example, two times. In this case, the path data 24 may have the rebounding points of three times or more. Alternatively, the number of the rebounding may be increased or decreased. A difficulty level may be adjusted.

When the number of the rebounding is equal to or less than the predetermined number, the path determination portion 16 proceeds to the next step S25 and determines whether or not the velocity of the object O moving along the path is within an allowable range. The time of displaying the object O is determined by the appearance time and the operation time of the sequence data 23, and also, the moving distance can be checked by the selected path data, the appearance position and the operation position. Therefore, the path determination portion 16 can calculate the velocity of the object O based on these data. The path determination portion 16 determines whether or not the velocity obtained by this calculation is within an allowable range. As the allowable range, a lower limit and an upper limit of the velocity of the object O can be set. The lower limit and the upper limit may be changed.

When the velocity is within the allowable range, the path determination portion 16 proceeds to the next step S26 and determines whether or not a crossing angle between the selected path and the determination line L at which the object O has to arrive is equal to or greater than a predetermined angle. When the crossing angle is less than the predetermined angle, it is difficult to determine an operation timing coinciding with the object and the determination line L, and therefore, a difficulty level tends to increase. The setting of the crossing angle may be changed. When the crossing angle is equal to or greater than the predetermined angle, the path determination portion 16 proceeds to the step S27, adopts the selected path and notify the selected path data to the sequence processing portion 14. Then, the path determination portion 16 quits the processing.

On the other hand, in a case that the operation coordinates are not included in the path data 24 selected in the step S23, the number of rebounding is greater than the predetermined number in the step S24, the velocity of the object O is out of the allowable range in the step S25 and the crossing angle between the determination line and the path is less than the predetermined angle in the step S26, the path determination portion 16 proceeds to step S28 and determines whether or not the path data 24 obtained in the step S22 obtains all path data 24 recorded in the game data 22. When all path data 24 is not obtained, the path determination portion 16 returns to the step S22, selects new path data among the path data 24 which are not yet selected and repeats processing subsequent to the step S23. On the other hand, when all path data 24 is obtained, the path determination portion 16 proceeds to the step S29 and generates path data. The case of proceeding to the step S29 means that the path data 24 satisfying the condition with respect to the determination line L at this time does not exist in the game data 22. For this reason, in the step S29, for example, the path determination portion 16 generates path data of a predetermined velocity and a predetermined angle with no rebounding point in the path arriving at the operation coordinates. The path data generated in the step S29 may be simple as long as these steps S23 to S26 are affirmatively judged. The number of rebounding of the generated path data, the velocity, and the crossing angle may be determined in advance. After generating the path data, the path determination portion 16 quits the processing. According to the above processing, the appearance position of the object O appearing in the game area A and the path thereof may be determined, and the path data may be selected.

In the above aspect, an external storage device 20 of the game machine 1 serves as a sequence data storage device, a path data storage device and an operation coordinates data storage device. Further, the control unit 10 serves as a direction determination device by making the direction determination portion 17 execute the determination line generation processing routine of FIG. 6, serves as a path determination device by making the path determination portion 16 execute the path determination processing routine of FIG. 7 and serves as a game area display device by making the sequence processing portion 14 execute the processing of steps S7 and S8 of the sequence processing routine of FIG. 5.

The present invention is not limited to the above-described aspect, and can be carried out in various kinds of aspects. For example, in this aspect, the operation time of the object O described in the sequence data 23 and the operation coordinates data 25 in accordance with the operation time correspond to each other, but the invention is not limited thereto. For example, the operation position necessary for operating by the player P may be randomly determined. In this aspect, instead of the step S3 of the sequence processing routine of FIG. 5, the sequence processing portion 14 may determine the operation coordinates corresponding to the random number generated by the lottery by allocating the random number to the operation coordinates based on the operation coordinates data 25. Further, without the operation coordinates data 25, the operation coordinates may be determined by allocating the random number to coordinates in the game area A and drawing a lottery in a similar manner. In this aspect, the above processing executed instead of the step S3 of the sequence processing routine serves as an operation coordinates determination device.

When the operation coordinates are randomly determined, all of the successive operation coordinates may not be located on the border line A1 of the game area A such that the determination line L does not coincide with the border line A1 of the game area A. When the operation coordinates which become a current reference (reference operation coordinates) are located on the border line A1, a lottery may be drawn except for the coordinates of the border line A1 such that coordinates of an operation position to be operated next time are not located on the border line A1. Further, when next operation coordinates are determined with respect to the reference operation coordinates, a lottery may be drawn except for a predetermined area including the reference operation coordinates. For example, a distance between successive operation coordinates has only to be equal to or greater than a predetermined value. In this manner, the entire game area A can be used, without the operation position being biased to an adjacent region.

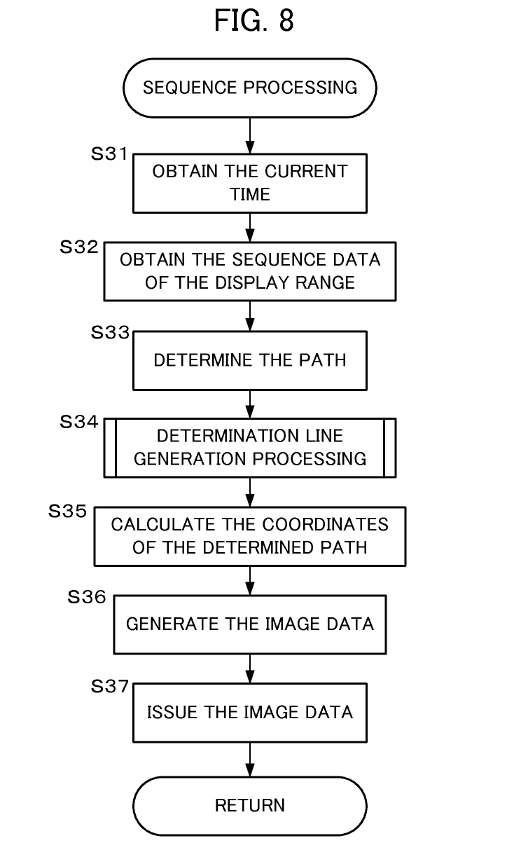

In this aspect, after the determination line L to appear next time is determined, the path of the object O is determined, but it is not limited to this. For example, after the path is determined, the determination line L may be determined. FIG. 8 is a flowchart showing a sequence processing routine according to one of variations. Since these steps S31 and S32 executed by the sequence processing portion 14 are the same processing as steps S1 and S2 described above, a description thereof will be omitted. In the next step S33, the sequence processing portion 14 determines a path. The path may be randomly determined from the path data 24 in the game data 22. As a specific example, one path data is selected among a total sixteen path data 24 in which four points are set as appearance positions p and four types of paths extending from the respective appearance positions p are set. In the next step S34, the sequence processing portion 14 executes a determination line generation processing routine in the direction determination portion 17. The determination line generation processing routine will be described below. Since these subsequent steps S35 to S37 are the same processing as steps S6 to S8, a description thereof will be omitted. In this variation, since the step S3 described above is unnecessary, the operation coordinates data 25 need not be prepared.

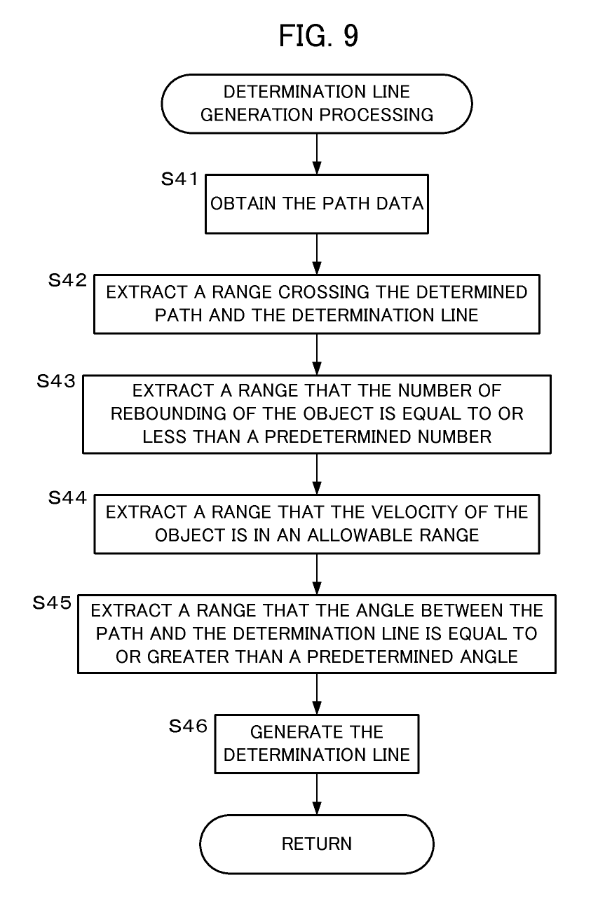

Next, the determination line generation processing routine which is executed by the direction determination portion 17 will be described with reference to FIG. 9. When the determination line generation processing of FIG. 9 is executed, in the step S41, the direction determination portion 17 first obtains the path data 24 determined in the step S33. In the next step S42, the direction determination portion 17 extracts a crossing range between the determined path and the determination line L extending from the reference operation position. The determination line L may extend from the reference operation position in a range of 360°, but, a range in which the determination line L and the path can be crossed is extracted from the range. The crossing point becomes next operation coordinates. In the next step S43, the direction determination portion 17 extracts an occurrence probability range of the determination line L in which the number of rebounding of the object O from the border line A1 is equal to or less than a predetermined number. Since the crossing point of the determination line L and the path becomes next operation coordinates, the operation coordinates become a terminal point of the object O. For this reason, a range in which the number of the rebounding points is equal to or less than a predetermined number is extracted because the rebounding points more than a predetermined number may be generated in some locations of the operation coordinates. As one example, when the number of the rebounding points is two or less, a range in which three or more rebounding points are generated is excluded from the range extracted from the step S42.

In the subsequent step S44, the direction determination portion 17 extracts an allowable range of the velocity of the object O. Since the velocity is determined based on the length of the path and time interval between the operation time corresponding to the reference operation position and the next operation time, the range is more narrowed by excluding the range having the crossing point more than a predetermined velocity. In the step S45, the direction determination portion 17 extracts a range in which an angle between the path and the determination line L is equal to or greater than a predetermined angle. In the next step S46, the direction determination portion 17 determines one angle based on the occurrence range of the determination line L extracted by the processing of these steps S42 to S45 and determines a direction in which the determination line L extends. When there is a plurality of angles at which the determination line L is generated, one of them is determined. The determination may be randomly made, or may be made by establishing a certain criteria. Coordinates necessary for displaying is obtained by calculating the determined determination line L. The direction determination portion 17 notifies the coordinates of the determination line L to the sequence processing portion 14, and quits the processing. Further, regarding these steps S42 to S45, a condition for determining the path of these steps S23 to S26 of the path determination processing of FIG. 7 is applied to a condition for determining the determination line L. In this variation, since the path is determined in advance, the determination line L satisfying these conditions is specified.

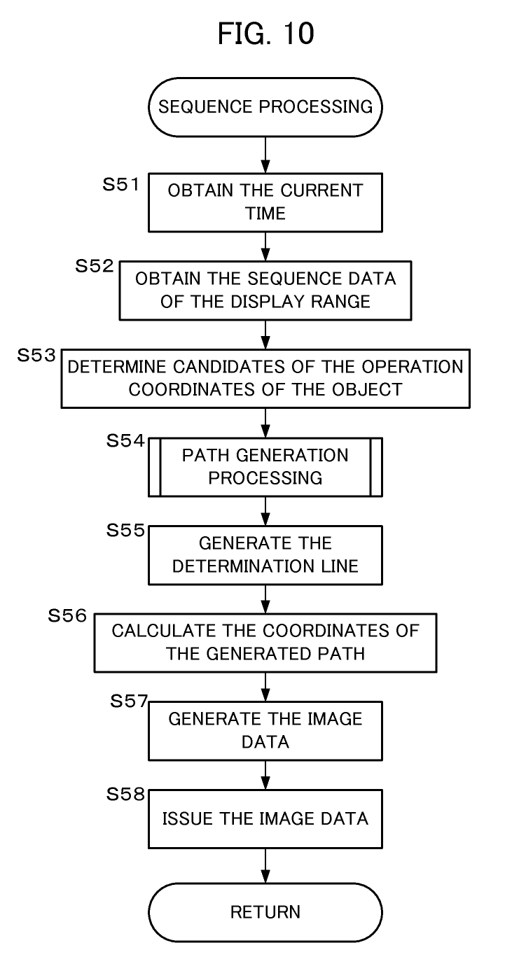

Further, the path data 24 has been described in a plurally stored type, but it is not limited to this. The path W of the object O appearing in the game area A may be generated. FIG. 10 is a flowchart showing a sequence processing routine according to another variation. Since these steps S51 and S52 the sequence processing portion 14 executes are the same processing as step S1 and S2 described above, a description thereof will be omitted. In the subsequent step S53, the sequence processing portion 14 determines candidates of operation coordinates of the object O to be operated next time. The candidates of the operation coordinates are on a circumference of a predetermined size around the reference operation position and obtain coordinates information on a predetermined radius. Certain coordinates among the operation coordinates candidates become operation coordinates to be operated next time. The size of the radius may be randomly determined. As the radius increases, the operation coordinates to be operated next time get far away. In the step S54, the sequence processing portion 14 makes the path determination portion 16 execute the path generation processing routine. The path generation processing routine will be described later. In the subsequent step S55, the sequence processing portion 14 determines operation coordinates to be operated next time based on the crossing point between the operation coordinates candidate of the step S53 and the path generated in the step S54 and generates the determination line L. Further, coordinates necessary for displaying is obtained by calculating the determined determination line L. Since these steps S56 to S58 are the same processing as these steps S6 to S8, a description will be omitted. In this variation, since the step S3 described above is unnecessary, the operation coordinates data 25 may not be prepared.

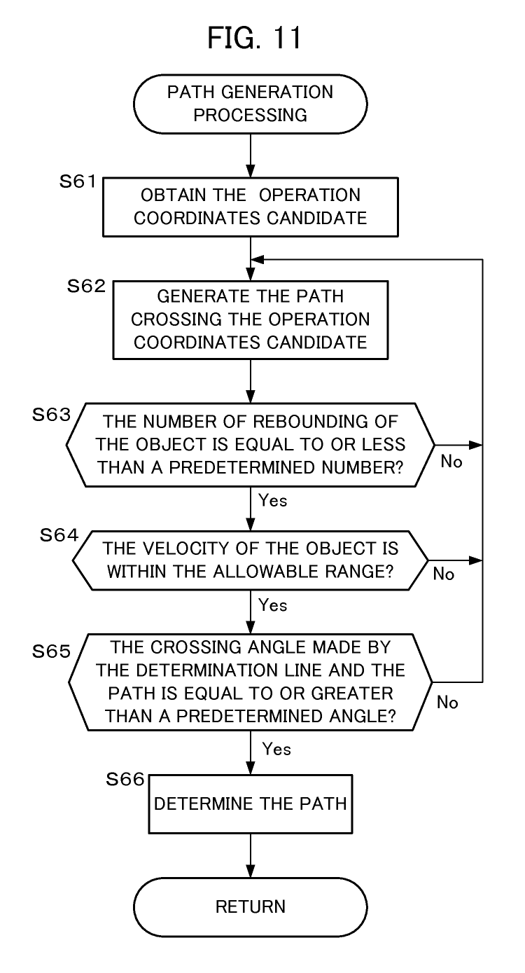

It will be described the path generation processing routine executed by the path determination portion 16 with reference to FIG. 11. When the path generation processing of FIG. 11 is executed, in step S61, the path determination portion 16 first obtains the coordinates information of the operation coordinates candidate determined in the step S53 described above. In the next step S62, the path determination portion 16 generates a path crossing the operation coordinates candidate. The path generated at this time may be a straight line such as a crossing at a certain position among the operation coordinates candidates. Alternatively, a straight line extending from the operation coordinates candidate may be generated. A rebounding point may be appropriately prepared such that the object O rebounds in the border line A1. The appearance position p may be provided in the game area A and the appearance position p may be in the border line A1 such that the object O appears from the border line A1.

In the subsequent step S63, the path determination portion 16 determines whether the number of rebounding points of the generated path is equal to or less than a predetermined number. When the number of the rebounding points (number of times of rebounding of the object O) is equal to or less than a predetermined number, the path determination portion 16 proceeds to the step S64 and determines whether or not the velocity of the object O moving along the path is within an allowable range. When the velocity of the object O is within the allowable range, the path determination portion 16 proceeds to the step S65 and determines whether or not a crossing angle formed between the path and the determine line L connecting a crossing point of the path and the operation coordinates candidate to the reference operation position is equal to or greater than a predetermined angle. When the crossing angle is equal to or greater than the predetermined angle, the path determination portion 16 proceeds to the step S66, determines the path generated in the step 62 as the path of the object O to appear next time and notifies the determined path to the sequence processing portion 14. Then, the path determination portion 16 quits the processing. On the other hand, when these conditions are not satisfied in these steps S63 to S65, the path determination portion 16 returns to the step S62, generates the path again and repeats the subsequent steps. Regarding these steps S62 to S65 of the processing, as with the above-described variation, a condition for determining the path of these steps S23 to S26 of the path determination processing of FIG. 7 is applied. In this aspect, the path is generated with respect to the operation coordinates candidate. Therefore, in the step S62, even though there is a slight modification from step S23, it is identical in that the path is generated to cross the determination line L. The path determination portion 16 serves as a path generation device by executing the path generation processing routine of FIG. 11.

In the appearance of the determination line L, even when the touch operation cannot be performed on the object O to be operated by the player P, the determination line L appears from the operation coordinates of the object O to be operated, or the object O2 which could not be touched disappears in the game area A, and the new determination line L appears from the disappearance position. However, in this case, elements disadvantageous to the progress of the game may be added. For example, the width of the determination line L generated when the player P does not performs the touch operation may be thicker or thinner. As described above, by making a change in the game, the game element is diversified. Further, the direction in which the determination line L appears may be randomly determined, and the point crossing the path determined after that may be determined as the operation coordinates. The determination of the appearance direction may be executed by a lottery or the like using a random number. Further, regarding the determination of the path, the above-described path determination processing may be used.

Further, regarding the operation of the object O, it has been described that one determination line L extends from the object O, but it is not limited to this. Two or more determination lines may appear. For example, in such a case that operation time of two operation coordinates are concurrent, the determination line L may extend to each of next two operation coordinates from the immediately previous operation coordinates. In this case, the path may be selected to avoid each of the determination lines L. Further, by associating the determination lines L with the colors of the objects O corresponding to the determination lines L, the determination lines L corresponding to the respective objects O may be distinguished by the colors.

Though, in this aspect, the game machine 1 is explained as the business use game machine, it is not limited to this. For example, a consumer use game machine, a mobile game machine, a mobile phone with gaming function, a game system using network and the like can be applied. The operating portion receiving the operation of the player P is not limited to the touch panel 4. For example, the operating portion may be a controller with various operation buttons, or the like. In this case, the designation of the object O to be operated may be automatically performed. Input device that can accept an audio input operation or an operation by a gaze can be applied.

1. A game system comprising:
a display device which displays a game screen;
an operating device which accepts an operation of a player;
a sequence data storage device which stores sequence data in which operation time of the operating device during a game is described;
a game area display device which makes the display device display a game area where an operation indicator for indicating an operation to the operating device and an operation reference portion where the operation indicator moves to arrive at an operation time indicated in the sequence data appear; and
a direction determination device which determines a direction of a new operation reference portion extending from the operation indicator based on the operation of the operating device when the operation indicator moving along a predetermined path arrives at an operation position coinciding with the operation reference portion.

2. The game system of claim 1, wherein
after the direction determination device determines an operation coordinates of the operation indicator to operate next with respect to the operation indicator to be operated by the player, the direction determination device determines the direction of the operation reference portion so as to extend in a direction of the operation coordinates.

3. The game system of claim 2, comprising
an operation coordinates data storage device which stores operation coordinates data in which operation coordinates of the operation position are described in association with the order of operations.

4. The game system of claim 2, comprising
an operation coordinates determination device which selects the operation coordinates of the operation position where the operation indicator arrives in the operation reference portion by a lottery from the coordinates in the game area.

5. The game system of claim 1, wherein
the direction determination device determines a direction of the new operation reference portion so as to cross a path where a next operation indicator to arrive the new operation reference portion moves.

6. The game system of claim 1, comprising
a path generation device which generates a path of the operation indicator arriving at the operation coordinates to be operated next so as to cross at a certain position of a candidate of the operation coordinates to be operated next provided on the circumference having a predetermined radius around the operation position.

7. The game system of claim 1, further comprising
a path data storage device which stores path data in which the appearance position of the operation indicator and the path where the operation indicator appearing from the appearance position moves are described, wherein
the path of the operation indicator determines based on the path data.

8. The game system of claim 7, further comprising
a path determination device which selects the path data including the operation coordinates of the operation reference portion at which the operation indicator to determine the path arrives.

9. The game system of claim 8, wherein
the path determination device selects the path data that the number of rebounding points where the operation indicator moving in the game area contacts with the border line surrounding the game area and rebounds is equal to or less than a predetermined number.

10. The game system of claim 8, wherein
in the sequence data, an appearance time of the operation indicator corresponding to the operation time is described, and
the path determination device determines the velocity of the moving operation indicator based on the appearance duration determined based on the appearance time and the operation time and the appearance position and the operation position of the path of the corresponding operation indicator, and selects the path data that the velocity is within a predetermined range.

11. The game system of claim 8, wherein
the path determination device selects the path data that a crossing angle between the operation reference portion to coincide with the operation indicator and the path of the moving operation indicator is equal to or greater than a predetermined angle.

12. A storage medium storing a computer program for a game system comprising:
a display device which displays a game screen;
an operating device which accepts an operation of a player; and
a sequence data storage device which stores sequence data in which operation time of the operating device during a game is described; wherein
the computer program causes the game system to serve as:
a game area display device which makes the display device display a game area where an operation indicator for indicating an operation to the operating device and an operation reference portion where the operation indicator moves to arrive at an operation time indicated in the sequence data appear; and
a direction determination device which determines a direction of a new operation reference portion extending from the operation indicator based on the operation of the operating device when the operation indicator moving along a predetermined path arrives at an operation position coinciding with the operation reference portion.
